(19) United States
(12) Patent Application Publication
(10) Pub. No.: US 2026/0208082 A1
(43) Pub. Date: Jul. 23, 2026

(54) EXTRUDED NETTING

(71) Applicant: DelStar Technologies, Inc., Alpharetta, GA (US)

(72) Inventor: Paul J. Huspeni, Austin, TX (US)

(21) Appl. No.: 19/451,463

(22) Filed: Jan. 16, 2026

Related U.S. Application Data
(60) Provisional application No. 63/747,520, filed on Jan. 21, 2025.

(51) Int. Cl. B01D 39/16

(52) U.S. Cl. CPC B01D 39/1623; B01D 2239/0216; B01D 2239/1233; B01D 2239/1291

(57) ABSTRACT

Support elements, spacers, filter media and filters are provided that are formed from reticular structures, such as nettings or meshes, and may be used in a variety of demanding filter applications that require high resistance to elevated temperatures, corrosive chemical environment and/or oxidative degradation. A reticular structure comprises an array of intersecting fibers coupled to each other. The intersecting fibers comprise a composition comprising a first polyphenylene sulfide (PPS) resin in about 50% to about 90% by weight of the composition and a second PPS resin in about 10% to about 40% by weight of the composition. The first PPS resin has a peak top molecular weight of a main peak component at least about 50% higher than the peak top molecular weight of the main peak component of the second PPS resin. The composition has an oxygen index (OI) of at least about 32.0 volume % O₂.

### CROSS-REFERENCE TO RELATED APPLICATIONS

This application claims the benefit of U.S. Provisional Application Ser. No. 63/747,520, filed Jan. 21, 2025, the complete disclosure of which is incorporated herein by reference in its entirety for all purposes.

### TECHNICAL FIELD

This description generally relates to extruded reticular structures comprising intersecting polymer strands or monofilaments, such as netting, meshes, screens and the like.

### BACKGROUND

Polymeric netting materials are used for a wide variety of applications, such as filtration, drainage, insulation, ground vibration damping, noise control and ventilation in buildings, resin infusion media, foam flow media and resin transfer media for vacuum infusion and structural injection molding, erosion control, soil consolidation, landfill stabilization, packaging, reinforcement, separation, containment, protection and the like. One particular application of polymeric netting materials is as a support element or backing materials in filters, such as air and liquid filters.

Polymeric nettings typically comprise flexible mattings produced from polymer monofilaments, such as polyamide, nylon, polyester, polypropylene, polyphenylene sulfide and the like. These monofilaments are thermally bonded together where they cross to form a flexible, compression resistant matrix with a substantial amount of void space. The tight, low profile crisscross pattern of the netting distributes a controlled, predictable flow of liquid solutions or gases throughout the laminate.

One material currently used in commercial nettings is polyphenylene sulfide (“PPS”). PPS resins are based on an organic polymer consisting of aromatic rings linked with sulfides, which can be molded, extruded, or machined. PPS can be formed into various moldings, films, sheets, fibers and the like by a common melt processing method such as extrusion molding, injection molding, or compression molding. PPS, however, can cause challenges during production because it generally has high melt viscosity, particularly at lower processing temperatures, making it difficult to achieve smooth, consistent flow during extrusion. The high viscosity can lead to poor die fill, uneven extrusion or increased wear on the screw and barrel.

Netting compositions made of PPS typically include at least one polyhedral oligomeric silsesquioxane (POSS) additive, which is a nano-structured chemical additive that improves the processability of the PPS resin. Incorporating POSS as a nanofiller into PPS during the extrusion process improves the flowability of PPS by reducing its melt viscosity, helping the material move more smoothly through the extruder, leading to better processing performance and easier handling of the material during extrusion. POSS, however, generally increases the cost of the netting material. In addition, POSS can complicate the processing parameters, requiring more precise control over temperature, mixing and extrusion conditions.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Extruded reticular structures, such as nettings or meshes, are provided that may be used in a variety of demanding applications that require resistance to elevated temperatures, corrosive chemical environments and/or oxidative degradation. The extruded reticular structures may include support elements, spacers and/or filter media for air and liquid filters, such as aerospace and automotive fuel, brake fluid and oil filtration, fencing, turf netting, drainage, insulation, ground vibration damping, noise control and ventilation in buildings, resin infusion media, foam flow media and resin transfer media for vacuum infusion and structural injection molding, erosion control, soil consolidation, landfill stabilization, packaging, protective sleeves, reinforcement, separation, containment, protection and the like.

In one aspect, a reticular structure comprises an array of intersecting fibers coupled to each other. The intersecting fibers comprise a composition comprising a first polyphenylene sulfide (PPS) resin in about 50% to about 90% by weight of the composition and a second PPS resin in about 10% to about 40% by weight of the composition. The composition has an oxygen index (OI) of at least about 32.0 volume % O₂.

In embodiments, the OI is at least about 35.0 volume % O₂. The OI is defined herein as the minimum concentration of oxygen, expressed as percent volume, that will just support flaming combustion in a flowing mixture of oxygen and nitrogen at 23+−2° C. as measured according to Procedure A of ASTM Standard Test Method D2863-23.

OI results have importance in classifying the flammability behavior of insulation and other components. Higher OI values may also translate into improved oxidative degradation resistance at elevated temperatures. Enhanced oxidative degradation resistance may be a benefit in filtration applications experiencing long-time exposure to elevated temperature and corrosive chemical environments, particularly in aerospace/automotive fuel, brake fluid, and oil filtration applications.

In embodiments, the first PPS resin has higher peak molecular weight (MW), molecular weight distribution (MWD) and/or weight average molecular weight (Mw) than the second PPS resin. “Weight average molecular weight (Mw)” refers to the average molecular weight of a sample where larger molecules contribute more to the average due to their greater mass, essentially meaning the calculation is weighted based on the weight fraction of each molecule size present in the sample, rather than just the number of molecules.

In embodiments, the first PPS resin has a peak of Mw that is higher than the peak of Mw of the second PPS resin. The “peak molecular weight” refers to the molecular weight value at the highest point of a MWD curve when analyzing a sample with a range of molecular weights.

In an exemplary embodiment, the first PPS resin has a peak top molecular weight of a main peak component of at least about 20% higher, or at least about 50% higher, or at least about 100% higher, or at least about 200% higher than the second PPS resin. The “peak top molecular weight” of a main peak component refers to the molecular weight corresponding to the highest point of a peak in a gel permeation chromatogram (GPC).

In certain embodiments, the first PPS resin has a peak top molecular weight of a main peak component in the range of about 100,000 to about 1,000,000 grams/mole. The second PPS resin has a peak top molecular weight of a main peak component in the range of about 75,000 to about 250,000 grams/mole.

In embodiments, the composition comprises about 75% to about 85% by weight of the first PPS resin and about 15% to about 25% by weight of the second PPS resin. In certain embodiments, the composition comprises about 82% by weight of the first PPS sulfide resin and 18% by weight of the second PPS resin. In other embodiments, the composition comprises 78% by weight of the first PPS resin, 18% by weight of the second PPS resin, and 4% by weight of a selected additive.

In embodiments, the composition comprises additional additives. In an exemplary embodiment, the composition comprises polypropylene in about 1% to about 10% by weight of the composition, or about 2% to about 8% by weight of the composition, or about 4% by weight of the composition.

In embodiments, the composition consists of the first and second polyphenylene sulfide resins. Thus, the composition is substantially (or entirely) devoid of polyhedral oligimeric silsequioxane (POSS). Applicant has discovered that a composition comprising the combination of first and second PPS materials provides sufficient processability during the extrusion process to render POSS superfluous. This reduces the overall cost of manufacture of the netting, and eliminates potential long-term environmental and health effects that have been associated with POSS. In addition, this may improve the netting's toughness (less brittle) and its resistance to impacts or mechanical stresses.

In embodiments, the reticular structure comprises an extruded polymeric netting produced from monofilaments or strands. The monofilaments or strands may be thermally bonded together where they cross to form a flexible, compression resistant matrix with a substantial amount of void space. The tight, low profile crisscross pattern of the netting distributes a controlled, predictable flow of fluid through the filter media.

In embodiments, the strands each have a thickness of about 4 mils to about 40 mils, or 10 mils to about 35 mils, or about 20 mils to about 30 mils. In certain embodiments, the strands may have a thickness of about 5 mils to about 7 mils, or about 6 mils.

In embodiments, the netting comprises a plurality of apertures or holes. The apertures may comprise pores or perforations. The apertures may have any suitable shape, such as circular, diamond shaped, elliptical, trilobal, square, rod, hexagonal, teardrop, oblong, triangular, rectangular, or a combination thereof. In an exemplary embodiment, the apertures have a substantially diamond shape. The apertures may have a size of at least about 500 microns, or at least about 10,000 microns, preferably at least about 2,500 microns.

In embodiments, the strands extend at an angle relative to each other of about 30 degrees to about 105 degrees, or about 60 degrees to about 90 degrees, or about 70 degrees. In an exemplary embodiment, the apertures formed by the strands are symmetrical although it will be recognized that the apertures may be non-symmetrical in certain embodiments.

The netting may have a basis weight of about 30 gsm to about 500 gsm, or about 50 gsm to about 200 gsm or about 75 gsm to about 125 gsm. The netting may be designed to have an air permeability of about 500 cfm to about 2000 cfm at 125 Pa, or about 700 cfm to about 1500 cfm at 125 Pa. In some embodiments (discussed below), the air permeability of each layer may differ.

The netting may have a strand density of about 3 strands per inch to about 35 strands per inch, or about 10 strands per inch to about 15 strands per inch.

In another aspect, a spacer or support element for use in a filter is provided. The spacer comprises a reticular structure comprising an array of intersecting fibers coupled to each other. The fibers comprise a composition comprising a first polyphenylene sulfide (PPS) resin in about 50% to about 90% by weight of the composition and a second PPS resin in about 10% to about 40% by weight of the composition. The composition has an oxygen index (OI) of at least about 32.0 volume % O₂, or at least about 35.0 volume % O₂.

In embodiments, the spacer or support element may be configured for placement between one or more filter media, which may comprise pleated or unpleated filters, porous or semi-permeable membranes or the like. The reticular structure, such as a netting may be configured to mechanically support and protect the membrane from damage to fluid flow through the filter assembly.

In embodiments, the first PPS resin has a peak top molecular weight of a main peak component of at least about 20% higher, or at least about 50% higher, or at least about 100% higher, or at least about 200% higher than the second PPS resin. In certain embodiments, the first PPS resin has a peak top molecular weight of a main peak component in the range of about 100,000 to about 1,000,000 grams/mole. The second PPS resin has a peak top molecular weight of a main peak component in the range of about 75,000 to about 250,000 grams/mole.

In another aspect, a filter is provided comprising the spacer or support element described above. The filter may comprise a reverse osmosis filter, a wastewater filter, a pleated filter for automotive fuel, break and hydraulic oil or gasoline, a fuel cell, a pleated air filter, an organic gas/air filter, a corrosive acid/base gas or air filter, a blood filter, a facemask, a resin infusion laminate, a semiconductor solution filter or the like.

In another aspect, a filter comprises a filter media, such as a porous or semi-permeable membrane, and a reticular structure disposed adjacent to the membrane. The extruded reticular structure comprises an array of intersecting fibers coupled to each other and comprising composition comprising a first polyphenylene sulfide (PPS) resin in about 50% to about 90% by weight of the composition and a second PPS resin in about 10% to about 40% by weight of the composition. The composition has an oxygen index (OI) of at least about 32.0 volume % O₂, or at least about 35.0 volume % O₂.

In embodiments, the first PPS resin has a peak top molecular weight of a main peak component of at least about 20% higher, or at least about 50% higher, or at least about 100% higher, or at least about 200% higher than the second PPS resin. In certain embodiments, the first PPS resin has a peak top molecular weight of a main peak component in the range of about 100,000 to about 1,000,000 grams/mole. The second PPS resin has a peak top molecular weight of a main peak component in the range of about 75,000 to about 250,000 grams/mole.

In embodiments, the reticular structure comprises about 75% to about 85% by weight of the first PPS resin and about 15% to about 25% by weight of the second PPS resin. In certain embodiments, the composition comprises about 82% by weight of the first PPS resin and 18% by weight of the second PPS resin. In other embodiments, the composition comprises 78% by weight of the first PPS resin and 18% by weight of the second PPS resin, and 4% of a selected additive.

In embodiments, the filter further comprises a second extruded reticular structure comprising first and second intersecting fibers coupled to each other and comprising a composition comprising a first polyphenylene sulfide (PPS) resin in about 50% to about 90% by weight of the composition and a second PPS resin in about 10% to about 40% by weight in the composition. The composition has an oxygen index (OI) of at least about 32.0 volume % O₂, or at least about 35.0 volume % O₂.

The membrane may be disposed between the first and second extruded reticular structures. In certain embodiments, the filter may comprise a plurality of porous membranes, which may comprise pleated or unpleated filter media, and a plurality of supporting netting disposed between each of the porous membranes. The supporting netting may function as a spacer between the porous membranes.

In embodiments, the permeable membrane comprises one or more materials selected to resist deformation at elevated temperatures to avoid compromising the integrity of the filter. The porous membrane may comprise the same material as the reticular structures. In other embodiments, the permeable membrane comprises a different material as the reticular structures.

The filter may be configured for use in a variety of industries, such as pulp and paper, food and beverage, steel production, industrial process fluids, wastewater, municipal, automotive, power generation, semiconductor manufacturing, mining/construction, petroleum/chemical refining, medical/pharmaceutical and general manufacturing. For example, the filter may comprise a liquid filter, an air filter, such as an HVAC filter, a reverse osmosis filter, a wastewater filter, an automotive pleated filter, a fuel cell, a microfiltration membrane, a blood filter, a hydraulic filter, a facemask, a semi-conductor solution filter or the like.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a perspective view of a reticular structure, such as a netting, for a filter;

FIG. 2 is a top view of a netting;

FIG. 3 is a top view of another embodiment of a netting;

FIG. 4 is a top view of another embodiment of a netting;

FIG. 5 is a top view of another embodiment of a netting;

FIG. 6 is a top view of another embodiment of a netting; and

FIG. 7 is a graph of the DMA parallel plate viscosity versus frequency for the first and second PPS resins.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Extruded reticular structures, such as nettings or meshes, are provided that may be used in a variety of demanding applications, such as support elements and/or filter media for air and liquid filters, such as aerospace and automotive fuel, brake fluid and oil filtration, fencing, turf netting, drainage, insulation, ground vibration damping, noise control and ventilation in buildings, resin infusion media, foam flow media and resin transfer media for vacuum infusion and structural injection molding, erosion control, soil consolidation, landfill stabilization, packaging, protective sleeves, reinforcement, separation, containment, protection and the like.

For example, netting for agriculture applications may include trellis, crop and animal protection, garden and nursey, hay bale, trees and shrubs, plastic fencing turf and sod netting and the like.

For example, netting for building and construction applications are provided that may include radiant barriers, rain screens, roofing materials, stucco systems, and nettings for piling packaging and transporting construction materials, such as paving blocks and bricks.

For example, netting is provided for consumer goods that may include consumer products packaging, protecting sleeves, mattress insulators, dust covers, quilt backers and the like.

For example, netting is provided for pipeline protection fiber and resin-based materials for wind turbines, wind blades and marine applications.

For example, netting for erosion control applications are provided, such as garden and nursery netting, soil stabilization netting and turf systems, paver netting, erosion control blanket netting, wattle netting, turf reinforcement mats and the like.

For example, filter media and filters are provided that are formed from extruded polymer materials, such as nettings. The filter media may be particularly useful in one or more of following industries: aerospace, automotive, aftermarket products, beverage dispensers, coalescing, computers, data centers, electronics, food service, NVACR, ice machines, industrial enclosures, injection molding, marine, medical, military, portable cooling, power generation, PTAC, reach-in coolers, refrigerated display cases, telecom, transportation, wind turbines, municipal, waste water, automotive, power generation, industrial process fluids, semiconductor, petroleum/chemical refining, pulp and paper, food and beverage, medical/pharmaceutical, general manufacturing and the like.

For example, various embodiments include air filters, such as high-efficiency particulate air (HEPA) filters, heating ventilation and air conditioner (HVAC) filters, activated carbon filters, electrostatic filters, minimum efficiency reporting value (MERV) filters, pre-filters, UV-C air filters, odor filters, fiberglass filters, pleated filters, RO filters, outer sleeves for cylindrical filters, face masks, CPAP filters, vacuum bags and the like.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include brake fluid filters, oil filters and/or fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include liquid filters suitable for use in semiconductor processing, such as microfiltration filters, chemical filters, CMP filters, lithography filters, process gas filters, chemical mechanical polishing filters, wastewater filters, wet etch and clean filters, pleated separators for semiconductor etching and/or filtering air in clean rooms, PFOA filters and the like. In one such embodiment, the filter comprises a pleated filter for semiconductor etching and cleaning solutions. In another embodiment, the filter is configured for use as an air molecular contamination filter for semiconductor manufacturing, e.g., filtering air in clean rooms.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, various embodiments include filters and/or packaging for the food and beverage industry are provided, such as produce bags, protective sleeves, pallet netting, meat, poultry and shellfish mesh, filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter centrifuges or filter presses for de-watering separated grains in, for example, a distillery or brewery.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

Referring now to FIG. 1, an extruded reticular structure 20 comprises an array of intersecting monofilaments or strands 30 bonded to each other to form a netting or mesh. The intersecting strands comprise a composition comprising a first polyphenylene sulfide (PPS) resin in about 50% to about 90% by weight of the composition and a second PPS resin blended with the first PPS resin in about 10% to about 40% by weight in the composition. The composition has an oxygen index (OI) of at least about 32.0 volume % O₂.

In embodiments, the OI is at least about 35.0 volume % O₂. The OI is defined herein as the minimum concentration of oxygen, expressed as percent volume, that will just support flaming combustion in a flowing mixture of oxygen and nitrogen at 23+−2° C. as measured according to Procedure A of ASTM Standard Test Method D2863-23. The OI test discerns the lowest concentration of oxygen required for a material to combust.

In embodiments, the first PPS resin has higher peak molecular weight (MW), molecular weight distribution (MWD) and/or weight average molecular weight (Mw) than the second PPS resin. “Weight average molecular weight (Mw)” refers to the average molecular weight of a sample where larger molecules contribute more to the average due to their greater mass, essentially meaning the calculation is weighted based on the weight fraction of each molecule size present in the sample, rather than just the number of molecules; this is particularly relevant when analyzing polymers with a distribution of chain lengths. A Mw of a PPS resin can be determined by size exclusion chromatography (SEC) including a differential refractive index detector on the basis of a calibration curve made by a relational expression between a molecular weight and a retention time, in which the relational expression is obtained by measuring a reference material whose molecular weight is known, and the molecular weight values and the charts of the PPS resin may be measured by gel permeation chromatography (GPC), which is a type of SEC, using polystyrene as a reference material.

Peak molecular weight (MW) refers to the molecular weight corresponding to the maximum in the molecular weight distribution curve of a polymer sample. In other words, it is the molecular weight of the most abundant polymer species in the sample, as determined from the distribution of molecular weights measured (for example, by gel permeation chromatography). Molecular weight distribution (MWD) refers to the range and relative proportions of different molecular weights present in a polymer sample. It describes how uniform or varied the polymer chain lengths are. MWD is typically quantified as the ratio of weight average molecular weight (Mw) to number average molecular weight (Mn), expressed as MWD=MwMnMWD=MnMw, where a higher ratio indicates a broader distribution of polymer chain lengths.

GPC chromatography equipment configured with a differential refractive index (RI) detector generates an initial curve/spectrum of species eluted volume (x-axis) vs. signal intensity (y-axis). The eluted volume corresponds to the MW of the dissolved species (polymers). The larger polymer species/chains are eluted first followed by progressively lower MW molecules and oligomers. The GPC chromatogram y-axis signal intensity is proportional to the mass of the of the species defined by the corresponding MW slice on the x-axis.

Critical parameters generated from SEC/GPC analyses include the following: (1) Molecular weight distribution (MWD)—the spectrum of MWs for a specified polymer sample; (2) Peak molecular weight Mₚ which correlates to the mode of the MWD; (3) Number average molecular weight Mₙ; (4) Weight average molecular weight Mw; (5) Polydispersity index Z=M_{w}/Mₙ.

Mₙ and M_{w} are defined as follows: Mₙ=ΣWᵢ/Σ(Wᵢ/Mᵢ) and M_{w}=Σ(WᵢMᵢ)/ΣWᵢ. Wᵢ=mass of species corresponding to molecular weight Mᵢ. Mᵢ=molecular weight of species i. The height of the GPC chromatogram y-axis RI detector signal for species i (hᵢ) is proportional to Wᵢ. Thus equations 1) and 2) above for Mₙ and M_{w} become: Mₙ=Σhᵢ/Σ(hᵢ/Mᵢ) and M_{w}=Σ(hᵢMᵢ)/Σhᵢ. Mₙ and M_{w} are related to critical polymer physical properties and processability. Polydispersity index Z is an indication of the breadth of the MWD. M_{w} is strongly correlated to processing viscosity, impact strength, tensile strength, toughness, and chemical/elevated temperature resistance.

In embodiments, the first PPS resin has a peak MW that is higher than the peak MW of the second PPS resin. The “peak molecular weight” refers to the molecular weight value at the highest point of a distribution curve when analyzing a sample with a range of molecular weights.

In an exemplary embodiment, the first PPS resin has a peak top molecular weight of a main peak component of at least about 20% higher, or at least about 50% higher, or at least about 100% higher, or at least about 200% higher than the second PPS resin. The “peak top molecular weight” of a main peak component refers to the molecular weight corresponding to the highest point of a peak in a chromatogram, usually obtained through techniques like size exclusion chromatography (SEC) or gel permeation chromatography (GPC), representing the most abundant molecular species within that peak distribution; essentially, it's the molecular weight at the very top of the main peak.

In embodiments, the term “peak top molecular weight of a main peak component” refers to the molecular weight corresponding to the apex of the largest or most prominent peak in a polymer sample's molecular weight distribution. This peak represents the most abundant polymer chains within the sample, and the peak top molecular weight quantifies the molecular weight of these chains. For example, when comparing two polymer samples, a first polymer may be described as having a peak top molecular weight of its main peak component that is at least about 50% higher than the peak top molecular weight of the main peak component of a second polymer, indicating that the first polymer contains a significantly greater proportion of larger polymer chains relative to the second polymer. The peak top molecular weight may be determined using techniques such as gel permeation chromatography or other methods capable of resolving the molecular weight distribution of the polymer.

In certain embodiments, the first PPS resin has a peak top molecular weight of a main peak component in the range of about 100,000 to about 1,000,000 grams/mole. The second PPS resin has a peak top molecular weight of a main peak component in the range of about 75,000 to about 250,000 grams/mole.

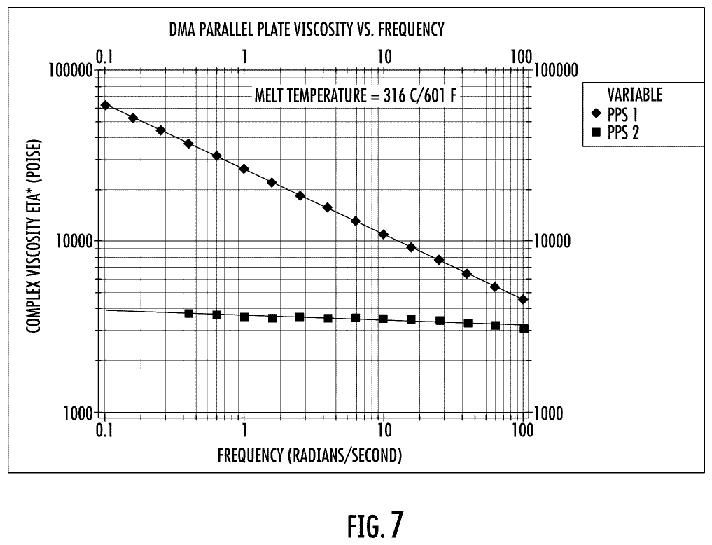

In embodiments, the first PPS resin has a significantly higher Dynamic Mechanical Analyzer (DMA) parallel plate complex viscosity (measured in poise) versus frequency or shear rate (measured in radians/second) than the second PPS resin (see FIG. 7). The first PPS resin is labeled PPS 1 and the second PPS resin is labeled PPS 2 in FIG. 7. This data was measured at a melt temperature of 316° C. (601° F.). “DMA parallel plate viscosity” refers to the measurement of a material's viscosity using a Dynamic Mechanical Analyzer (DMA) with a parallel plate geometry, where a sample is placed between two parallel plates, and its viscous properties are analyzed by observing its response to oscillating forces applied to the plates. Essentially, it allows you to determine the material's resistance to flow under dynamic conditions by measuring the energy dissipation within the sample during deformation. The parallel plate complex viscosity is closely associated with molecular weight distribution (MWD) for a specified molecular configuration/chemistry (linear, branched, copolymer, etc.). Thus, the first PPS resin has a higher molecular weight (MW) than the second PPS resins.

In embodiments, the composition comprises about 75% to about 85% by weight of the first polyphenylene sulfide resin and about 15% to about 25% by weight of the second polyphenylene sulfide resin. In certain embodiments, the composition comprises about 82% by weight of the first polyphenylene sulfide resin and 18% by weight of the second polyphenylene sulfide resin. In other embodiments, the composition comprises 78% by weight of the first polyphenylene sulfide resin, 18% by weight of the second polyphenylene sulfide resin, and 4% by weight of a selected additive.

The netting may include additional materials for color, UV stabilizers, antistatics, flame retardant additives, antimicrobial additives, such as silver, triclosan, heavy metals and the like. In an exemplary embodiment, the composition comprises polypropylene in about 1% to about 10% by weight of the composition, or about 2% to about 8% by weight of the composition, or about 4% by weight of the composition.

In embodiments, the composition consists of the first and second polyphenylene sulfide resins. Thus, the composition is substantially (or entirely) devoid of polyhedral oligimeric silsequioxane (POSS). Applicant has discovered that a composition comprising the combination of first and second PPS materials provides sufficient processability during the extrusion process to render POSS superfluous. This reduces the overall cost of manufacture of the netting, and eliminates potential long-term environmental and health effects that have been associated with POSS. In addition, this may improve the netting's toughness (less brittle) and its resistance to impacts or mechanical stresses. In some instances, POSS nanoparticles may agglomerate into clusters, leading to non-uniform properties in the final extrudate. In addition, POSS may lead to increased brittleness of the material and reduce the overall ductility and impact resistance of the material, making it more prone to cracking or failure under certain dynamic and high-stress applications.

In embodiments, the strands each have a thickness of about 4 mils to about 40 mils, or 10 mils to about 35 mils, or about 20 miles to about 30 mils. In certain embodiments, the thickness may be about 4 mils to about 8 mils, or about 5 mils to about 7 mils, or about 6 mils. Thickness of the overall netting is measured with a mechanical gauge with a 1 “D circular foot that contacts the circular surface. Individual strand dimensions are measured using vernier dial calipers or optical microscopy. The legs of the caliper are opened by moving a wheel. The strands are held with the machine direction facing downward. The stationary leg of the caliper is placed against one side of the strand and the caliper legs are gently closed until snug. The caliper legs are parallel to the machine direction. The thickness (to a thousands of an inch) can be read on the dial scale and the linear scale.

The netting may be formed from any suitable method such as extrusion, co-extrusion, bi-component, and elastomeric nettings. In an exemplary embodiment, the netting is formed from a mono-extrusion or co-extrusion process. Generally, suitable methods for making the extruded netting includes extruding a polymeric blend composition through dies with reciprocating or rotating parts to form the netting configuration. This creates cross machine direction strands that cross a second set of machine direction strands, which flow continuously. After the extrusion, the netting is then typically stretched in the machine direction using a differential between two sets of nip rollers.

Each layer of netting may have a basis weight of about 30 gsm to about 500 gsm or about 50 gsm to about 200 gsm or about 75 gsm to about 125 gsm. The netting may be designed to have an air permeability of about 500 cfm to about 2000 cfm at 125 Pa, or about 700 cfm to about 1500 cfm at 125 Pa.

The netting comprises a plurality of apertures or holes. The apertures may comprise pores or perforations. The apertures may have any suitable shape, such as circular, diamond shaped, elliptical, trilobal, square, rod, hexagonal, teardrop, oblong, triangular, rectangular, or a combination thereof. In an exemplary embodiment, the apertures have a substantially diamond shape. The apertures may have a size of at least about 500 microns, or at least about 10,000 microns, preferably at least about 2,500 microns.

In embodiments, the strands extend at an angle relative to each other of about 30 degrees to about 105 degrees, or about 60 degrees to about 90 degrees, or about 70 degrees, or about 75 degrees depending on the application. In an exemplary embodiment, the apertures formed by the strands are symmetrical although it will be recognized that the apertures may be non-symmetrical in certain embodiments.

The netting may have a strand density of about 3 strands per inch to about 35 strands per inch, or about 10 strands per inch to about 15 strands per inch. Strand count (per inch) was measured with an SPI measurement template (6×6 inch) aluminum template and the Bausch & Lomb linen tester (Model N8869 or approved equivalent) per the following procedure: (1) Cut a full width sample from a roll and place on a flat surface. Samples of “sleeve” materials should be cut open along one edge and opened flat; (2) Label side that touches the spreader (inside strands) as Side A and label side that does not touch the spreader (outside strands) as Side B; (3) With Side B facing down, lay the template near the center of the sample and determine the “Bottom” strand count (Side B) and “Top” strand count (Side A) using the counting instrument and the template; (4) Determine the average strand count for both Side A and Side B strands by dividing the number of strands counted by 3; and (5) Report the average strand count for Side A and Side B to the nearest tenth of a strand.

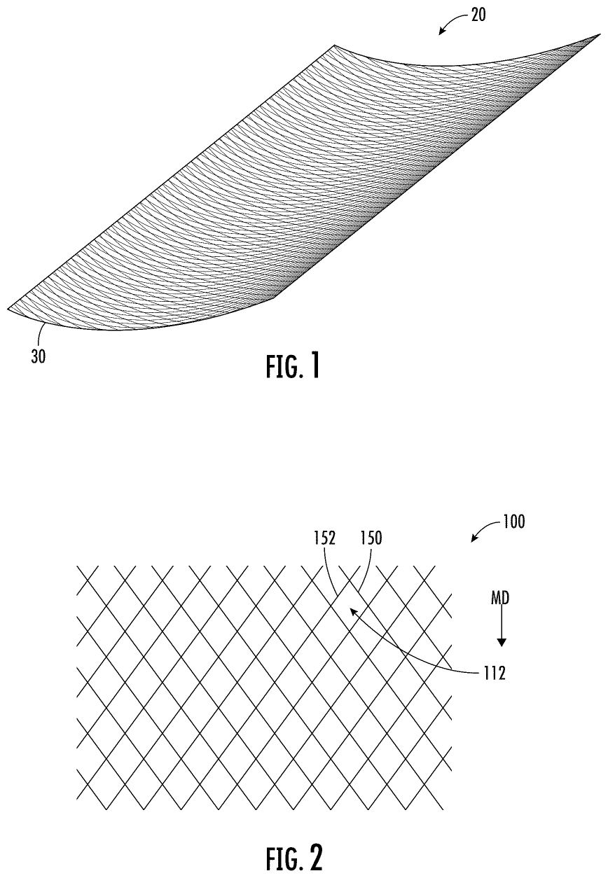

Referring now to FIG. 2, in one embodiment a netting 100 comprises apertures 112 formed from a first series of strands 150 extending in one direction and a second series of strands 152 extending in a generally crosswise or transverse direction. The strands 150, 152 extend in directions relative to each other such that apertures 112 have a substantially diamond shape. The first and second sets of strands 150, 152 are extruded polymeric elongate members which cross and intersect during extrusion to form the net-like structure. The strands could also be formed of extruded strands that are knitted together rather than crossed during extrusion. In an exemplary embodiment, the apertures 112 formed by the strands are symmetrical although it will be recognized that the apertures may be non-symmetrical in certain embodiments. In the FIG. 2 embodiment, both sets of strands 150, 152 are at an angle to the machine direction (MD) and have substantially the same number and size (e.g., thickness). MD is the direction a material moves or unwinds through a machine.

In some embodiments, the strands are made of the same material. In other embodiments, the first set of strands 150 are made of a different material than the second set of strands 152. For example, the netting may include 10 to 90 wt. % of the material of the first set of strands 150 and 10 to 90 wt. % of the material of the second set of strands 152. In still other embodiments, the netting may include 45 to 55 wt. % of the material of strands 150 and 45 to 55 wt. % of the material of strands 152.

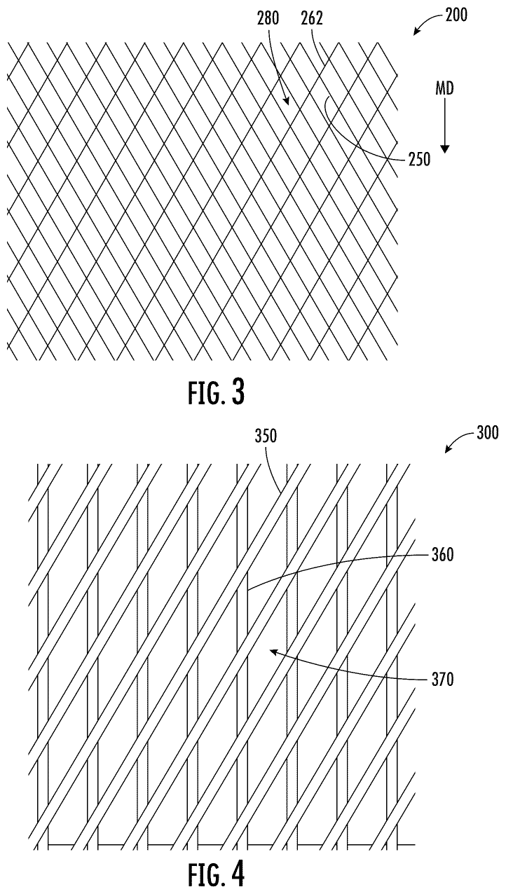

FIGS. 3-6 show several additional examples of nettings that can be used with the filter media described herein. FIG. 3 illustrates an example of an asymmetrical netting 200 wherein both sets of strands 250, 262 are at an angle to the MD, but are different in number and/or size. As shown, strands 250 are thinner than strands 262. In addition, there are a greater number of strands 250 than strands 262. The strands 250, 262 form apertures 280 with an asymmetric diamond shape.

FIG. 4 illustrates another example of a non-symmetrical netting 300 wherein one set of strands 350 is an at angle to the MD and the other set of strands 360 is substantially parallel to the MD. The strands 350, 360 may have the same number and thickness or they may have a different number and/or thickness. The strands 350, 360 form apertures 370 with a substantially diamond shape.

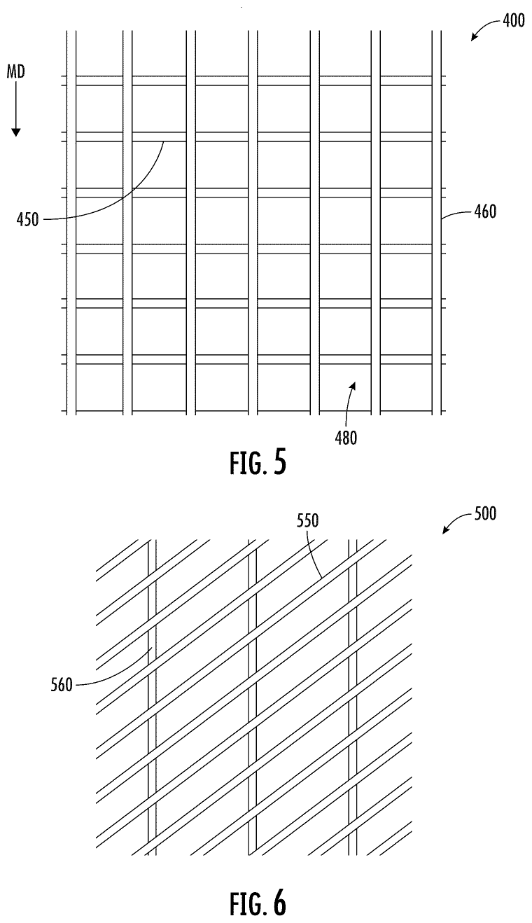

FIG. 5 illustrates another example of a netting 400 wherein one set of strands 450 is substantially parallel to the CD and the other set of strands 460 is substantially parallel to the MD. CD is the direction that is 90 degrees relative to the MD. The strands 450, 460 may have the same number and thickness or they may have a different number and/or thickness. In this embodiment, the strands 450, 460, form apertures 480 that are substantially square in shape.

FIG. 6 illustrates another embodiment of a non-symmetrical netting 500 wherein one set of strands 550 is an at angle to the MD and the other set of strands 560 is substantially parallel to the MD. In this embodiment, strands 560 may have different thicknesses as they extend across the width or length of the netting.

In certain embodiments, the reticular structures discussed herein may be included as part of a filter device or assembly that traps or absorbs contaminants. In one such embodiment, the filter assembly comprises a porous or semi-permeable membrane and an extruded reticular structure disposed adjacent to the membrane. The extruded reticular structure comprises an array of intersecting strands bonded to each other; examples include netting, meshes, screens and the like.

A filter membrane may be porous, non-porous or have skinned surfaces (porous or non-porous). The membrane may be single or multilayer and include symmetric or asymmetric (and combinations) of pore sizes across the thickness of the membrane. The membrane may be pleated or unpleated. The membrane may comprise nonwoven or woven fibers and may be cast or extruded. The fibers may be meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or combinations thereof.

In embodiments, the filter further comprises a second extruded reticular structure comprising first and second intersecting strands bonded to each other and comprising a first polyphenylene sulfide (PPS) resin in about 50% to about 90% by weight of the composition and a second PPS resin blended with the first PPS resin in about 10% to about 40% by weight in the composition.

In embodiments, the first PPS resin has higher molecular weight than the second PPS resin. In an exemplary embodiment, the first PPS resin has a molecular weight of at least about 2% higher, or at least about 5% higher, or at least about 10% higher, or at least about 25% higher than the second PPS resin.

The membrane may be disposed between the first and second extruded reticular structures. For example, the reticular structures or netting may be provided on both the outflow and inflow sides of the membrane, wherein “outflow” and “inflow” refer to the direction of fluid flow through the filter. The netting may be configured to mechanically support and protect the membrane from damage to fluid flow through the filter assembly.

In certain embodiments, the filter assembly may comprise a plurality of porous membranes, which may comprise pleated or unpleated filter media, and a plurality of supporting netting disposed between each of the porous membranes. In various embodiments, the supporting netting includes channels or openings therein for fluid to pass through the supporting netting to the surface of the porous members and ensures separation between pleats of the filter portion. This is beneficial because if the pleats of the filter membranes are packed directly against each other, they could form a fluid tight seal against one another that blocks flow through the filter assembly.

The porous membrane preferably comprises a high-temperature thermoplastic material selected to resist deformation at elevated temperatures to avoid compromising the integrity of the filter and to endure continuous service at elevated temperatures. The porous membrane may comprise the same material as the reticular structures, or it may comprise a different material.

Suitable media for the porous membranes include, but are not limited to, meltblown, spunbond, needle felt, paper/cellulose, microglass medias and combinations thereof.

The porous membrane may comprise one or more fibers, which may be artificial or natural fibers. Suitable materials for the fibers include, but are not limited to, metallic fibers, carbon fibers, polypropylene (PP), polyesters (PET), PEN polyester, PCT polyester, polybutylene (PBT), ethylene polyester (PET), polylactic acid (PLA), polyamide (PA), co-polyamides, polyethylene, high density polyethylene (HDPE), low density polyethylene (LDPE), cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof.

In certain embodiments, the fibers within the substrate may comprise polyolefins, polyester, polyethylene (PE), polypropylene (PP), blends of PP and PE, PBT, PET, CoPET, PLA, PA, PHB, PVOH, PVA polyamide and a combination thereof. In an exemplary embodiment, the substrate comprises bicomponent fibers, such as CoPET/PET or HDPE/PET.

The fibers may be manufactured and formed into the substrate in any suitable manner including, but not limited to, meltblown, spunbond or spunlace, gradient spunbond, thermally bonded, bonded carded, air-laid, wet-laid, cellulose wet-laid, glass wet-laid, synthetic wet-laid, composite wet-laid, co-formed, needlepunched, stitched, hydraulically entangled, hydroentangled, ultrasonically bonded or the like. In all of the above examples, the fibers may be hydroentangled or hydraulically entangled. In one exemplary embodiment, the web formation is either drylaid (carded), wetlaid or bicomponent spunbond. In a particularly preferred embodiment, the substrate comprises wetlaid bicomponent fibers, such as CoPET/PET or HDPE/PET.

The fibers within the substrate may have many shapes in cross-section, including without limitation, circular, kidney bean, dog bone, trilobal, barbell, bowtie, star, Y-shaped, and others. With different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

In certain embodiments, the filter may also include nanoparticles incorporated into the netting and/or the porous membrane. The nanoparticles increase the overall surface area within the filter media, which increases its filtration efficiency and allows for the capture of submicron contaminants without significantly compromising other factors, such as pressure drop (i.e., fluid flow) through the filter. A more complete description of filter medias incorporating nanoparticles can be found in commonly assigned, co-pending International Patent Application Nos. PCT/US23/17921, filed Apr. 7, 2023 and PCT/US24/49846, filed Oct. 3, 2024, the complete disclosures of which are incorporated herein by reference in their entirety for all purposes.

In certain embodiments, one or more of the layers of the filter media may be electrostatically charged such that, for example, contaminants are captured both with mechanical and electrostatic filtration. The fibers can be electrostatically charged using triboelectric charging, corona discharge, electrostatic fiber spinning, hydro charging, charging bars or other known methods. One suitable method for triboelectric charging is described in U.S. Pat. No. 9,074,301, the entire disclosure of which is hereby incorporated by reference herein for all purposes.

One or more different layers of the filter media may comprise charge additives, charge adjuvants or a charge control agent (CCA), or any agent added during the production of a charged layer to increase the charges generated on the layer. The CCA's include but are not limited to metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, aryleneialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicyclic acid, potassium tetaphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urthene compound, metal complex of salicyclic acid compound, oxazolidinones, piperazines or perfluorinated alkane, lecigran MT, nigrosine, fumed silca, carbon black, para-trifluoromethyl benzoic acid and ortho-fluoro benzoic acid, poly(styrene-covinylpyridinium toluene sulfonate), methyl or butyltriphenyl complex aromatic amines, triphenylamine dyes and azine dyes, alkyldimethylbenzylammonium salts and combinations thereof. A more complete description of suitable CCAs that may be used can be found in U.S. Pat. No. 10,571,137, which is incorporated herein by reference in its entirety for all purposes.

Alternatively, the charge adjuvant may belong to the group of organic triazine compounds or oligomers with at least one additional nitrogen-containing group, as disclosed for example in WO 97/07272, in the following referred to as “triazine based charge adjuvant” or “TB-CA”.

In some embodiments, one or more of the layers may include a nucleating agent, or an agent added to a polymer melt which promotes crystallization of a semi-crystalline polymer from the melt. In an exemplary embodiment, the nucleating agent is a clarifier. The nucleating agent may be selected from a group consisting of benzoate salt, a sorbitol acetate, a rosin based nucleating agent, a carboxylic acid amide, a salt of an organophosphorous acid and mixtures thereof. A more complete description of suitable nucleating agents can be found in U.S. application Ser. No. 18/036,369, filed Nov. 10, 2020, the complete disclosure of which is incorporated herein by reference in its entirety for all purposes.

In certain embodiments, one or more of the extruded reticular layers in the filter media may include a silicone-based coating. In embodiments, the silicone-based coating comprises a reactive silicone macroemulsion. Silicone emulsions are insoluble silicones substantially evenly dispersed in water with the aid of a surfactant. The silicone emulsion may comprise, for example, dimethyl silicone emulsions, amino type silicone emulsions, organo-functional silicone emulsions, resin type silicone emulsions, film-forming silicone emulsions or the like. In an exemplary embodiment, the reactive silicone macroemulsion comprises an amino functional polydimethylsiloxane and/or a polyethylene glycol monotridecyl ether. In embodiments, the amino functional polydimethylsiloxane comprises about 30 to about 40 percent by weight of the coating. In embodiments, the polyethylene glycol monotridecyl ether comprises about 5 to about 10 percent by weight of the coating. A more complete description of suitable silicone-based coatings can be found in commonly assigned co-pending U.S. Application No. 18,464,484, filed Sep. 14, 2022 and U.S. Provisional patent application Ser. No. 18/560,813, filed Mar. 4, 2024, the complete disclosures of which are incorporated herein by reference for all purposes.

### Examples

The Applicant conducted testing of two nettings each comprised of two different PPS compositions: (1) Sample 1 comprised a composition comprising a first polyphenylene sulfide (PPS) resin in 82% by weight of the composition and a second PPS resin blended with the first PPS resin in 18% by weight in the composition; and (2) Sample 2 comprises a composition comprised of the polyphenylene sulfide (PPS) resin of Sample 2 in 99% by weight of the composition and a Hybrid Plastics trisilanohphenyl POSS in about 1% by weight of the composition. In Sample 1 above, the first PPS resin has higher molecular weight than the second PPS resin.

The oxygen index (OI) was tested for each of Samples 1 and 2. The OI test was measured according to ASTM Standard Test Method D2863-23. The OI is defined herein as the minimum concentration of oxygen, expressed as percent volume, that will just support flaming combustion in a flowing mixture of oxygen and nitrogen at 23+−2° C. under the conditions of the test method. The upper end of the sample is ignited and the subsequent burning behavior of the sample is observed to compare the period for which burning continues, or the length of sample burned, with specified limits for each burning. By testing a series of samples in different oxygen concentrations, the minimum oxygen concentration is determined. The testing was conducted according to Procedure A of ASTM Standard Test Method D2863-23, wherein a complete assessment of the oxygen index is conducted using top surface ignition.

The OI test discerns the lowest concentration of oxygen required for a material to combust. By positioning a specimen in an undisturbed territory and meticulously ameliorating oxygen tiers until self-sustained burning ceases, the OI value is acquired. Oxygen index testing is a critical laboratory operation vital for demarcating the flammability of materials.

The OI standard deviation values (0.1 volume % O₂ gas) were based on OI measurements performed on six (6) of each of Sample 1 and Sample 2. The results of this testing are shown below in TABLES 1-3

TABLE 1

| ASTM D2863 | Oxygen Index Values | Oxygen Index Values |
|---|---|---|
| Pass (“◯”)/ | (Volume % O₂) | (Volume % O₂) |
| Fail (“X”) Rating | PPS Netting Sample 1 | PPS Netting Sample 2 |
| ◯ | 35.0 | 31.0 |
| X | 35.2 | 31.2 |
| ◯ | 35.0 | 31.0 |
| X | 35.2 | 31.2 |
| ◯ | 35.0 | 31.0 |
| X | 35.2 | 31.2 |

TABLE 2

| | PPS Netting | PPS Netting |
|---|---|---|
| Parameter | Sample 1 | Sample 2 |
| Average % O₂ | 35.1 | 31.1 |
| Sample Std. Dev. | 0.1095 | 0.1095 |
| X_{bar1} − X_{bar2} | 4.0000 | (—) |
| (n₁ − 1)*s₁²) + ((n₂ − 1)*s₂²) | 0.1200 | (—) |
| n₁ + n₂ − 2 | 10 | (—) |
| (1/n₁) + (1/n₂) | 0.3333 | )—) |
| Std. Error of the Mean | 0.0632 | 0.0632 |
| t-Statistic | 63.2456 | 63.2456 |
| N | 6 | 6 |

TABLE 3

| | PPS Netting | PPS Netting |
|---|---|---|
| Parameter | Sample 1 | Sample 2 |
| Average % O₂ | 35.1 | 31.1 |
| Variance | 0.012 | 0.012 |
| Observations | 6 | 6 |
| Hypothesized Mean Difference | 0 | |
| df | 10 | |
| t Stat | 63.2455532 | |
| P(T ∠= t) one-tail | 1.18796E−14 | |
| T Critical one-tail | 1.812461123 | |
| P(T ∠= t) two-tail | 1.37591E−14 | |
| T Critical two-tail | 2.228138852 | |

As shown above, Sample 1 had a significantly greater average OI relative to Sample 2 (35.1 volume % O₂ versus 31.1 volume % O₂). The 2-sample mean t-test indicates that there is a statistically significant (P-value about 10-14) difference between the OI in Samples 1 and 2. The Applicant notes that the trisilanolphenyl POSS molecule contains carbon-based phenyl groups as well as oxygen which could affect the Sample 2 netting OI. It is possible that the trisilanolphenyl POSS additive may catalyze the combustion of PPS in an oxygen-rich atmosphere.

OI results have importance in classifying the flammability behavior of insulation and other components. Higher OI values may also translate into improved oxidative degradation resistance at elevated temperatures. Enhanced oxidative degradation resistance may be a benefit in filtration applications experiencing long-time exposure to elevated temperature and corrosive chemical environments, particularly in aerospace/automotive fuel, brake fluid, and oil filtration applications.

The OI test discloses a material's vulnerability to ignition and capacity to nourish combustion-proficiency critical in fire-prone settings like buildings, aircraft, and trains. Materials boasting high OI values display definitive resistance to combustion, making them resistant to ignition and flame production. For instance, materials with an OI surpassing 30% are classified as non-flammable, while those plunging below 21% are highly flammable. These values form the basis for categorizing materials into fire peril classes, with Class A signifying the vastly fire-resistant and Class D indicating the extensively flammable.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a reticular structure comprising an array of intersecting fibers coupled to each other, wherein the intersecting fibers comprise a composition comprising a first polyphenylene sulfide (PPS) resin in about 50% to about 90% by weight of the composition and a second PPS resin in about 10% to about 40% by weight of the composition; and wherein the composition has an oxygen index (OI) of at least about 32.0 volume % O₂.

A second embodiment is the first embodiment, wherein the OI is at least about 35.0 volume % O₂.

A third embodiment is any combination of the above embodiments, wherein the first PPS resin has a higher molecular weight and/or molecular weight distribution than the second PPS resin.

A 4^{th} embodiment is any combination of the above embodiments, wherein the composition comprises about 75% to about 85% by weight of the first PPS resin and about 15% to about 25% by weight of the second PPS resin.

A 5^{th} embodiment is any combination of the above embodiments, wherein the composition comprises 82% by weight of the first PPS resin and 18% by weight of the second PPS resin.

A 6^{th} embodiment is any combination of the above embodiments, wherein the composition comprises 78% by weight of the first PPS resin, 18% by weight of the second PPS resin.

A 7^{th} embodiment is any combination of the above embodiments, further comprising an additive.

An 8^{th} embodiment is any combination of the above embodiments, wherein the additive comprises polypropylene.

A 9^{th} embodiment is any combination of the above embodiments, wherein the composition comprises about 4% by weight of the polypropylene.

A 10^{th} embodiment is any combination of the above embodiments, wherein the composition consists of the first and second polyphenylene sulfide resins.

An 11^{th} embodiment is any combination of the above embodiments, wherein the first and second polyphenylene sulfide resins are extruded together to form the reticular structure.

A 12^{th} embodiment is any combination of the above embodiments, wherein the composition is devoid of polyhedral oligimeric silsequioxane (POSS).

A 13^{th} embodiment is any combination of the above embodiments, wherein the intersecting strands have a thickness of about 5 mils to about 40 mils.

A 14^{th} embodiment is any combination of the above embodiments, wherein the thickness is about 5 mils to about 10 mils.

A 15^{th} embodiment is any combination of the above embodiments, wherein the extruded reticular structure comprises a netting with apertures having a size of about 500 microns to about 10,000 microns.

A 16^{th} embodiment is any combination of the above embodiments, wherein the netting has a basis weight of about 30 gsm to about 500 gsm.

A 17^{th} embodiment is any combination of the above embodiments, wherein the apertures have a shape selected from the group consisting of circular, diamond shaped, elliptical, trilobal, square, rod, hexagonal, teardrop, oblong, triangular, rectangular, or a combination thereof.

An 18^{th} embodiment is any combination of the above embodiments, wherein the apertures have a substantially diamond shape.

A 19^{th} embodiment is any combination of the above embodiments, wherein the extruded reticular structure has a strand density of about 3 strands per inch to about 35 strands per inch.

A 20^{th} embodiment is any combination of the above embodiments, wherein the strand density is about 25 strands per inch to about 35 strands per inch.

A 21^{st} embodiment is any combination of the above embodiments, wherein the first and second strands extend at an angle relative to each other of about 30 degrees to about 105 degrees.

A 22^{nd} embodiment is any combination of the above embodiments, wherein the angle is about 70 degrees.

A 23^{rd} embodiment is a reinforcement netting comprising the support element of any combination of the above embodiments.

A 24^{th} embodiment is a filter comprising the support element of any combination of the above embodiments.

A 25^{th} embodiment is a containment netting comprising the support element of any combination of the above embodiments

A 26^{th} embodiment is a protecting netting comprising the support element of any combination of the above embodiments

A 27^{th} embodiment is any combination of the above embodiments, wherein the first PPS resin has a peak top molecular weight of a main peak component at least about 50% higher than the peak top molecular weight of the main peak component of the second PPS resin.

A 28^{th} embodiment is any combination of the above embodiments, wherein the first PPS resin has a peak top molecular weight of a main peak component of about 100,000 to about 1,000,000 grams/mole.

A 29^{th} embodiment is any combination of the above embodiments, wherein the second PPS resin has a peak top molecular weight of a main peak component of about 75,000 to about 250,000 grams/mole.

A 30^{th} embodiment is a filter media comprising: a reticular structure comprising an array of intersecting fibers coupled to each other; wherein the intersecting fibers comprise a composition comprising a first polyphenylene sulfide (PPS) resin in about 50% to about 90% by weight of the composition and a second PPS resin in about 10% to about 40% by weight of the composition; and wherein the composition has an oxygen index (OI) of at least about 32.0 volume % O₂.

A 31^{st} embodiment is the 30^{th} embodiment and any combination of the above embodiments.

A 32^{nd} embodiment is any combination of the above embodiments, wherein the OI is at least about 35.0 volume % O₂.

A 33^{rd} embodiment is any combination of the above embodiments, wherein the first PPS resin has a higher molecular weight and/or molecular weight distribution than the second PPS resin.

A 34^{th} embodiment is any combination of the above embodiments, wherein the composition comprises about 75% to about 85% by weight of the first PPS resin and about 15% to about 25% by weight of the second PPS resin.

A 35^{th} embodiment is any combination of the above embodiment, wherein the composition comprises 82% by weight of the first PPS resin and 18% by weight of the second PPS resin.

A 36^{th} embodiment is any combination of the above embodiments, wherein the composition comprises 78% by weight of the first PPS resin, 18% by weight of the second PPS resin.

A 37^{th} embodiment is any combination of the above embodiments, further comprising an additive.

A 38^{th} embodiment is any combination of the above embodiments, wherein the additive comprises polypropylene.

A 39^{th} embodiment is any combination of the above embodiments, wherein the composition comprises about 4% by weight of the polypropylene.

A 40^{th} embodiment is any combination of the above embodiments, wherein the composition consists of the first and second polyphenylene sulfide resins.

A 41^{st} embodiment is any combination of the above embodiments, wherein the composition is devoid of polyhedral oligimeric silsequioxane (POSS).

A 42^{nd} embodiment is a filter and any combination of the above embodiments.

A 43^{rd} embodiment is a filter comprising: a porous membrane; a reticular structure comprising an array of intersecting fibers coupled to each other disposed adjacent to the porous membrane; and wherein the intersecting fibers comprise a composition comprising a first polyphenylene sulfide (PPS) resin in about 50% to about 90% by weight of the composition and a second PPS resin in about 10% to about 40% by weight of the composition; and wherein the composition has an oxygen index (OI) of at least about 32.0 volume % 02.

A 44^{th} embodiment is the 40^{th} embodiment and any combination of the above embodiments.

A 45^{th} embodiment is any combination of the above embodiments, wherein the OI is at least about 35.0 volume % O₂.

A 46^{th} embodiment is any combination of the above embodiments, wherein the first PPS resin has a higher molecular weight and/or molecular weight distribution than the second PPS resin.

A 47^{th} embodiment is any combination of the above embodiments, further comprising a second extruded reticular structure comprising an array of intersecting strands bonded to each other, wherein the porous membrane is disposed between the first and second extruded reticular structures.

A 48^{th} embodiment is any combination of the above embodiments, wherein the porous membrane is pleated.

A 49^{th} embodiment is any combination of the above embodiments, wherein the composition comprises about 75% to about 85% by weight of the first PPS resin and about 15% to about 25% by weight of the second PPS resin.

A 50^{th} embodiment is any combination of the above embodiments, wherein the composition comprises 82% by weight of the first PPS resin and 18% by weight of the second PPS resin.

A 51^{st} embodiment is any combination of the above embodiments, wherein the composition consists of the first and second PPS resins.

A 52^{nd} embodiment is any combination of the above embodiments, wherein the composition is devoid of polyhedral oligimeric silsequioxane (POSS).

A 53^{rd} embodiment is any combination of the above embodiments, wherein the strands have a thickness of about 5 mils to about 40 mils.

A 54^{th} embodiment is any combination of the above embodiments, wherein the extruded reticular structure comprises a netting with apertures having a size of about 500 microns to about 10,000 microns.

A 55^{th} embodiment is any combination of the above embodiments, wherein the apertures have a shape selected from the group consisting of circular, diamond shaped, elliptical, trilobal, square, rod, hexagonal, teardrop, oblong, triangular, rectangular, or a combination thereof.

A 56^{th} embodiment is any combination of the above embodiments, wherein the apertures have a substantially diamond shape.

A 57^{th} embodiment is a liquid filter and any combination of the above embodiments.

A 58^{th} embodiment is an air filter and any combination of the above embodiments.

What is claimed is:

1. A reticular structure comprising:
an array of intersecting fibers coupled to each other;
wherein the intersecting fibers comprise a composition comprising a first polyphenylene sulfide (PPS) resin in about 50% to about 90% by weight of the composition and a second PPS resin in about 10% to about 40% by weight of the composition; and
wherein the composition has an oxygen index (OI) of at least about 32.0 volume % O₂.

2. The reticular structure of claim 1, wherein the OI is at least about 35.0 volume % O₂.

3. The reticular structure of claim 1, wherein the first PPS resin has a higher molecular weight than the second PPS resin.

4. The reticular structure of claim 1, wherein the first PPS resin has a peak top molecular weight of a main peak component at least about 50% higher than the peak top molecular weight of the main peak component of the second PPS resin.

5. The reticular structure of claim 1, wherein the first PPS resin has a peak molecular weight of a main peak component of about 100,000 to about 1,000,000 grams/mole.

6. The reticular structure of claim 1, wherein the second PPS resin has a peak top molecular weight of a main peak component of about 75,000 to about 250,000 grams/mole.

7. The reticular structure of claim 1, wherein the composition comprises about 75% to about 85% by weight of the first PPS resin and about 15% to about 25% by weight of the second PPS resin.

8. The reticular structure of claim 1, wherein the composition comprises 82% by weight of the first PPS resin and 18% by weight of the second PPS resin.

9. The reticular structure of claim 1, further comprising polypropylene.

10. The reticular structure of claim 1, wherein the composition consists of the first and second polyphenylene sulfide resins.

11. The reticular structure of claim 1, wherein the composition is devoid of polyhedral oligimeric silsequioxane (POSS).

12. The reticular structure of claim 3, wherein the intersecting strands have a thickness of about 5 mils to about 40 mils.

13. A filter media comprising:
a reticular structure comprising an array of intersecting fibers coupled to each other; and
wherein the intersecting strands comprise a composition comprising a first polyphenylene sulfide (PPS) resin in about 50% to about 90% by weight of the composition and a second PPS resin in about 10% to about 40% by weight of the composition; and
wherein the composition has an oxygen index (OI) of at least about 32.0 volume % O₂.

14. The filter media of claim 13, wherein the OI is at least about 35.0 volume % O₂.

15. The filter media of claim 13, wherein the first PPS resin has a higher molecular weight than the second PPS resin.

16. The filter media of claim 13, wherein the first PPS resin has a peak top molecular weight of a main peak component at least about 50% higher than the peak top molecular weight of the main peak component of the second PPS resin.

17. The filter media of claim 13, wherein the first PPS resin has a peak top molecular weight of a main peak component of about 100,000 to about 1,000,000 grams/mole.

18. The filter media of claim 13, wherein the second PPS resin has a peak top molecular weight of a main peak component of about 75,000 to about 250,000 grams/mole.

19. The filter media of claim 13, wherein the composition comprises about 75% to about 85% by weight of the first PPS resin and about 15% to about 25% by weight of the second PPS resin.

20. The filter media of claim 13, wherein the composition comprises 82% by weight of the first PPS resin and 18% by weight of the second PPS resin.
